(19) United States
(12) Patent Application Publication
(10) Pub. No.: US 2024/0014481 A1
(43) Pub. Date: Jan. 11, 2024

(54) ALL SOLID STATE BATTERY

(71) Applicant: SAMSUNG ELECTRO-MECHANICS CO., LTD., Suwon-si, Gyeonggi-do (KR)

(72) Inventors: Kyung-Lock Kim, Suwon-si, Gyeonggi-do (KR); Bon-Seok Koo, Suwon-si, Gyeonggi-do (KR); Young-Jin Hwang, Suwon-si, Gyeonggi-do (KR); Myung-Jin Jung, Suwon-si, Gyeonggi-do (KR); Jeong-Wook Kim, Suwon-si, Gyeonggi-do (KR)

(73) Assignee: SAMSUNG ELECTRO-MECHANICS CO., LTD., Suwon-si, Gyeonggi-do (KR)

(21) Appl. No.: 18/036,569

(22) PCT Filed: Oct. 1, 2021
(86) PCT No.: PCT/KR2021/013517

§ 371 Date: May 11, 2023

(30) Foreign Application Priority Data
Dec. 31, 2020 (KR) 10-2020-0189538

(51) Int. Cl. H01M 50/172; H01M 50/533; H01M 50/547

(52) U.S. Cl. CPC H01M 50/172; H01M 50/533; H01M 50/547

(57) ABSTRACT

An all solid state battery includes a battery body including first and second surfaces opposing each other in a first direction of the battery body, third and fourth surfaces opposing each other in a second direction of the battery body, and fifth and sixth surfaces opposing each other in a third direction of the battery body, a solid electrolyte layer, and a cathode layer and an anode layer stacked in the third direction with the solid electrolyte layer therebetween, a cathode penetration electrode, and an anode penetration electrode opposing the cathode penetration electrode in the second direction; a cathode terminal; and an anode terminal. An average margin of the cathode layer from an edge of the cathode layer to the third surface in the second direction is within a range of 15% or more and 30% or less of an average width of the battery body in the second direction.

### TECHNICAL FIELD

The present disclosure relates to an all solid state battery.

### BACKGROUND ART

Recently, devices that use electricity as an energy source are increasing. As application fields of devices using electricity such as smartphones, camcorders, notebook PCs. and electric vehicles are expanding, interest in electric storage devices using electrochemical devices is increasing. Among various electrochemical devices, a lithium secondary battery capable of charging and discharging, having a high operating voltage, and having a remarkably large energy density is in the spotlight.

The lithium secondary battery is manufactured by applying a material capable of intercalating and desorbing lithium ions into an anode and a cathode, and injecting a liquid electrolyte between the anode and the cathode. Electricity is generated or consumed by an oxidation-reduction reaction resulting from intercalation and desorption of lithium ions in the cathode and the anode. Such a lithium secondary battery needs to basically be stable in an operating voltage range of the battery and have the ability to transfer ions at a sufficiently high speed.

When a liquid electrolyte such as a non-aqueous electrolyte is used for such a lithium secondary battery, the lithium secondary battery has advantages of large discharge capacity and energy density. However, the lithium secondary battery has problems in that it is difficult to implement a high voltage, and highly risky in an electrolyte leakage, fire and explosion.

In order to solve the above problems, a secondary battery to which a solid electrolyte is applied instead of a liquid electrolyte has been proposed as an alternative. Solid electrolytes may be classified as a polymer-based solid electrolyte or a ceramic-based solid electrolyte, of which the ceramic-based solid electrolyte has an advantage of illustrating high stability. Research for applying such a ceramic-based solid electrolyte battery to various fields has been conducted, and demand for a solid electrolyte battery satisfying mechanical reliability and which has sufficient capacity is increasing.

### DISCLOSURE OF INVENTION

### Technical Problem

An aspect of the present disclosure may provide an all solid state battery having excellent mechanical reliability.

Another aspect of the present disclosure may provide an all solid state battery capable of being miniaturized and securing sufficient capacity.

Another aspect of the present disclosure may provide an all solid state battery having improved mounting freedom.

### Solution to Problem

According to an aspect of the present disclosure, an all solid state battery may include a battery body including first and second surfaces opposing each other in a first direction of the battery body, third and fourth surfaces opposing each other in a second direction of the battery body, and fifth and sixth surfaces opposing each other in a third direction of the battery body, a solid electrolyte layer, and a cathode layer and an anode layer stacked in the third direction with the solid electrolyte layer therebetween, a cathode penetration electrode penetrating in the battery body and connecting the cathode layer, and an anode penetration electrode penetrating in the battery body and connecting the anode layer and opposing the cathode penetration electrode in the second direction; a cathode terminal connected to the cathode penetration electrode; and an anode terminal connected to the anode penetration electrode. An average margin of the cathode layer from an edge of the cathode layer to the third surface in the second direction may be within a range of 15% or more and 30% or less of an average width of the battery body in the second direction.

According to an aspect of the present disclosure, an all solid state battery may include a battery body including first and second surfaces opposing each other in a first direction of the battery body, third and fourth surfaces opposing each other in a second direction of the battery body, and fifth and sixth surfaces opposing each other in a third direction of the battery body, a solid electrolyte layer, and a cathode layer and an anode layer stacked in the third direction with the solid electrolyte layer therebetween, a cathode penetration electrode penetrating in the battery body and connecting the cathode layer, and an anode penetration electrode penetrating in the battery body and connecting the anode layer and opposing the cathode penetration electrode in the second direction; a cathode terminal connected to the cathode penetration electrode; and an anode terminal connected to the anode penetration electrode. An average margin of the cathode layer from an edge of the cathode layer to the first surface or the second surface in the first direction may be within a range of 5% or more and 10% or less of an average length of the battery body in the first direction.

### Advantageous Effects of Invention

As set forth above, according to an exemplary embodiment in the present disclosure, a mechanical reliability of an all solid state battery may be improved.

According to an exemplary embodiment in the present disclosure, a miniaturization of the all solid state battery and the all solid state battery having a sufficient capacity may be simultaneously provided.

According to an exemplary embodiment in the present disclosure, a mounting freedom of the all solid state battery may be improved.

### BRIEF DESCRIPTION OF DRAWINGS

FIG. 1 is a schematic perspective view illustrating an all solid state battery according to an exemplary embodiment in the present disclosure;

FIG. 2 is a bottom view of FIG. 1;

FIG. 3 is a cross-sectional view taken along line 1-1′ of FIG. 1;

FIG. 4 is a schematic plan view illustrating a cathode layer of a multilayer ceramic electronic component according to an exemplary embodiment in the present disclosure;

FIG. 5 is a schematic plan view illustrating an anode layer of a multilayer ceramic electronic component according to an exemplary embodiment in the present disclosure:

FIG. 6 is a schematic bottom view illustrating a modified example of an all solid state battery according to an exemplary embodiment in the present disclosure;

FIG. 7 is a schematic perspective view illustrating a modified example of an all solid state battery according to an exemplary embodiment in the present disclosure;

FIG. 8 is a schematic perspective view illustrating a modified example of an all solid state battery according to an exemplary embodiment in the present disclosure; and

FIG. 9 is a perspective view illustrating a modified example of an all solid state battery according to an exemplary embodiment in the present disclosure.

### MODE FOR THE INVENTION

The above and other aspects, features, and advantages of the present disclosure will be more clearly understood from the following detailed description taken in conjunction with the accompanying drawings.

Hereinafter, exemplary embodiments of the present disclosure will now be described in detail with reference to the accompanying drawings.

In the drawings, an X direction may be defined as a first direction, an L direction, a length direction, or a Y direction may be defined as a second direction, and a W direction, a width direction, or a Z direction may be defined as a third direction, a T direction, or a thickness direction.

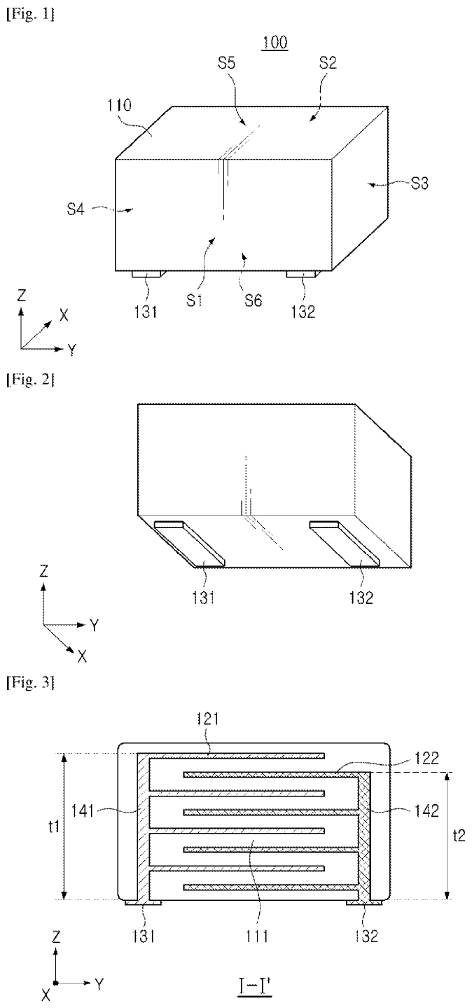

The present disclosure relates to an all solid state battery 100. FIGS. 1 through 5 are schematic views illustrating the all solid state battery 100 according to an exemplary embodiment in the present disclosure. Referring to FIGS. 1 through 5, the all solid state battery 100 according to the present disclosure may include a battery body 110 including first and second surfaces S1 and S2 opposing each other in a first direction (X direction), third and fourth surfaces S3 and S4 opposing each other in a second direction (Y direction), and fifth and sixth surfaces S5 and S6 opposing each other in a third direction (Z direction), a solid electrolyte layer 111 and a plurality of cathode layers 121 and anode layers 122 stacked in the third direction (Z direction) with the solid electrolyte layer 111 therebetween, a cathode penetration electrode 141 connecting the plurality of cathode layers 121, an anode penetration electrode 142 connecting the plurality of anode layers 122, a cathode terminal 131 connected to the cathode penetration electrode 141, and an anode terminal 132 connected to the anode penetration electrode 142.

In this regard, an average margin a of the cathode layer 121 in the second direction may be in a range of 15% or more and 30% or less of an average width A of the battery body 110 in the second direction. FIGS. 4 and 5 schematically illustrate the cathode layer 121 and the anode layer 122 of the all solid state battery 100 according to the present disclosure. As illustrated in FIGS. 4 and 5, the cathode layer 121 of the all solid state battery 100 according to the present disclosure may have the average margin a in the second direction, and the battery body 110 may have the average width A in the second direction.

An all solid state battery may have a superior stability and a high charge/discharge speed compared to a secondary battery of the related art, but has problems in that an interface resistance between an electrode and an electrolyte layer is high and it is difficult to secure a sufficient capacity. In order to solve these problems, a multilayer type all solid battery is developed, but it is common to use a structure in which an external terminal electrode is formed on a head surface of a battery body like a passive part of the related art. In this case, there are problems in that a gap may occur between the battery body and the external terminal electrode, or a resistance may increase due to an uneven shape, and a capacity of the battery relative to a volume thereof decreases due to the protruding external terminal electrode. In the above exemplary embodiment of the present disclosure, an electrode exposed to the outside is minimized, thereby maintaining a low resistance while increasing the mechanical strength of the all solid battery, and a separate external terminal electrode is not disposed on a head surface, thereby miniaturizing the parts itself.

The body 110 of the all solid state battery 100 according to the present disclosure includes the solid electrolyte layer 111, the cathode layer 121, the anode layer 122, the cathode penetration electrode 141, and the anode penetration electrode 142.

In an exemplary embodiment of the present disclosure, the solid electrolyte layer 111 according to the present disclosure may be at least one selected from the group consisting of a Garnet-type, Nasicon-type, LISICON-type, and perovskite-type, and LiPON-type.

The Garnet-type solid electrolyte may refer to a lithium-lanthanum zirconium oxide (LLZO) expressed in LiₐLa_{b}Zr_{c}O₁₂ such as Li₇La₃Zr₂O₁₂. The Nasicon-type solid electrolyte may refer to lithium-aluminum-titanium-phosphate (LATP) of Li₁₊ₓAlₓTi₂₋ₓ (PO₄)₃ (0<x<1) with Ti introduced into an Li₁₊ₓAlₓM₂₋ₓ(PO₄)₃ (LAMP) (0<x<2, M=Zr, Ti, Ge)-type compound, lithium-aluminum-germanium-phosphate (LAGP) expressed in Li₁₊ₓAlₓGe₂₋ₓ(PO₄)₃ (0<x<1) such as Li_{1.3}Al_{0.3}Ti_{1.7}(PO₄)₃ with an excess of lithium introduced therein, and/or lithium-zirconium-phosphate (LZP) of LiZr₂(PO₄)₃.

In addition, the LISICON-type solid electrolyte may refer to a solid solution oxide expressed in xLi₃AO₄−(1−x)Li₄BO₄ (A:P, As, V, etc., B:Si, Ge, Ti, etc.), and including Li₄Zn(GeO₄)₄, Li₁₀GeP₂O₁₂ (LGPO), Li_{3.5}Si_{0.5}P_{0.5}O₄, Li_{10.42}Si(Ge)_{1.5}P_{1.5}Cl_{0.08}O_{11.92}, etc. and a solid solution sulfide including Li₂S—P₂S₅, Li₂S—SiS₂, Li₂S—SiS₂—P₂S₅, Li₂S—GeS₂, etc. expressed in Li₄₋ₓM_{1-y}M′_{y}S₄ (M=Si, Ge and M′=P, Al, Zn, Ga).

Also, the perovskite-type solid electrolyte may refer to lithium-lanthanum titanate (LLTO) expressed in Li₃ₓLa_{2/3-x□t/3-2x}TiO₃ (0<x<0.16, oxygen vacancy) such as Li_{1/2}La_{5/8} TiO₃, etc. The LiPON-type solid electrolyte may refer to a nitride such as lithiumphosphorus-oxynitride such as Li_{2.8}PO_{3.3}NO_{0.46}.

In an example, the cathode layer 121 of the all solid state battery 100 according to the present disclosure may include a cathode active material and a conductive material. For example, the cathode layer 121 of the all solid state battery 100 according to the present disclosure may be an integrated cathode layer 121 in which the cathode active material and the conductive material are mixed and disposed.

The cathode active material may be, for example, a compound expressed in the following equation: LiₐA_{1-b}M_{b}D₂ (where, 0.90≤a≤1.8, 0≤b≤0.5); LiₐE_{1-b}M_{b}O_{2-c}D_{c} (where 0.90≤a≤1.8, 0≤b≤0.5, 0≤c≤0.05); LiE_{2-b}M_{b}O_{4-c}D_{c} (where 0≤b≤0.5, 0≤s≤0.05); LiaNi_{1-b-c}Co_{b}M_{c} D_{α} (where 0.90≤a≤1.8, 0≤b≤0.5, 0≤c≤0.05, 0<α≤2); LiₐN_{1-b-c}Co_{b}M_{c}O_{2-α}X_{α} (where 0.90≤a≤1.8, 0≤b≤0.5, 0≤c≤0.05, 0<α<2); LiₐNi_{1-b-c}Co_{b}M_{c}O_{2-α}X₂ (where 0.90≤a≤1.8, 0≤b≤0.5, 0≤c≤0.05, 0<α<2); LiₐNi_{1-b-c}Mn_{b}M_{c}D_{α} (where 0.90≤a≤1.8, 0≤b≤0.5, 0≤c≤0.05, 0<α≤2); LiₐNi_{1-b-c}Mn_{b}M_{c}O_{2-α}X_{α} (where, 0.90≤a≤1.8, 0≤b≤0.5, 0≤c≤0.05, 0<α<2); LiₐNi_{1-b-c}Mn_{b}M_{c}O_{2-α}X₂ (where, 0.90≤a≤1.8, 0≤b≤0.5, 0≤c≤0.05, 0<α<2); LiₐNi_{b}E_{c}G_{d}O₂ (where, 0.90≤a≤1.8, 0≤b≤0.9, 0≤c≤0.5, 0.001≤d≤0.1); LiₐNi_{b} Co_{c}Mn_{d}G_{c}O₂ (where, 0.90≤a≤1.8, 0≤b≤0.9, 0≤c≤0.5, 0≤d≤0.5, 0.001≤e≤0.1); LiₐNiG_{b}O₂ (where, 0.90≤a≤1.8, 0.001≤b≤0.1); LiₐCoG_{b}O₂ (where, 0.90≤a≤1.8, 0.001≤b≤0.1); LiₐMnG_{b}O₂ (where, 0.90≤a≤1.8, 0.001≤b≤0.1); LiₐMn₂G_{b}O₄ (where, 0.90≤a≤1.8, 0.001≤b≤0.1); QO₂; QS₂; LiQS₂; V₂O₅; LiV₂O₂; LiRO₂; LiNiVO₄; Li_{(3-f)}J₂ (PO₄)₃ (0≤f≤2); Li_{(3-f)}Fe₂(PO₄), (where, 0≤f≤2); and LiFePO₄, in the above equation, A is Ni, Co, or Mn; M is Al, Ni, Co, Mn, Cr, Fe. Mg, Sr, V, or a rare-earth element); D is O, F, S, or P; E is Co or Mn; X is F, S, or P; G is Al, Cr, Mn, Fe, Mg, La, Ce, Sr, or V; Q is Ti, Mo or Mn; R is Cr, V, Fe, Sc, or Y; J is V, Cr, Mn, Co, Ni, or Cu.

The cathode active material may also be LiCoO₂, LiMnₓO₂, (where, x=1 or 2), LiNi₁₋ₓMnₓO₂ (where, 0<x<1), LiNi_{1-x-y}CoₓMn_{y}O₂ (where, 0≤x≤0.5, 0≤y≤0.5), LiFePO₄, TiS₂, FeS₂, TiS₃, or FeS₃, but is not limited thereto.

The conductive material is not particularly limited as long as it has conductivity without causing a chemical change in the all solid state battery 100 of the present disclosure. For example, conductive materials such as graphite, such as natural graphite, artificial graphite, or etc., carbon-type materials such as carbon black, acetylene black, ketjen black, channel black, furnace black, lamp black, thermal black, etc.; conductive fibers such as carbon fiber, metal fiber, or etc.; carbon fluoride; metal components such as lithium (Li), tin (Sn), aluminum (Al), nickel (Ni), copper (Cu), etc., oxides, nitrides or fluorides thereof: conductive whiskers such as zinc oxide, potassium titanate, etc.; conductive metal oxides such as titanium oxide, etc.; polyphenylene derivatives, etc.

In an example of the present disclosure, the cathode layer 121 of the all solid state battery 100 may further include a solid electrolyte component. The solid electrolyte component may use one or more of the above-described components, and may function as an ion conduction channel in the cathode layer 121, and thus an interface resistance may be reduced.

In an exemplary embodiment of the present disclosure, the average margin a of the cathode layer 121 according to the present disclosure in the second direction may satisfy a range of 15% or more and 30% or less of the average width A of the body in the second direction (the Y direction). In the present specification, a “width” of a member may refer to a distance measured in a direction parallel to the second direction, and a “length” of a member may refer to a distance measured in a direction parallel to the first direction. In addition, an “average width” may refer to an arithmetic average of a width measured at a point divided into 10 equal intervals in the third direction of the member with respect to a cut surface (a YZ plane) cut in a direction passing through the center of an all solid state battery and simultaneously perpendicular to the X axis, and an “average length” may refer to an arithmetic average of a width measured at a point divided into 10 equal intervals in the third direction of the member with respect to a cut surface (an XZ plane) cut in a direction passing through the center of the all solid state battery and simultaneously perpendicular to the Y axis. In addition, the average margin may be an arithmetic average of values measured at 10 points of a cathode layer/anode layer closest to the 10 points where the average width and/or length are measured.

When the cathode layer 121, the solid electrolyte layer 111, and the anode layer 122 are stacked and sintered, there may be a problem in that a strength of a completed battery decreases due to a low adhesion between an electrode layer including the metal component and the active material and the solid electrolyte layer 111. In particular, as the size of the battery becomes smaller, the area where solid electrolyte layers are bonded to each other through a margin portion decreases, and the mechanical reliability of the battery itself may decrease. In the case of the all solid state battery 100 according to the present disclosure, when the average margin a of the cathode layer 121 in the second direction satisfies the above range, a sufficient adhesion area between the solid electrolyte layers 111 disposed above and below the cathode layer 121 may be secured, thereby improving the mechanical strength of the all solid state battery 100.

In an example, an average margin b of the cathode layer 121 of the all solid state battery 100 according to the present disclosure in the first direction may be within a range of 5% or more and 10% or less of an average length B of the battery body 110 in the first direction. The average margin b of the cathode layer 121 in the first direction may function to provide adhesion between the solid electrolyte layers disposed above and below the cathode layer 121 in the same manner as the average margin in the second direction described above. When the average margin b of the cathode layer 121 in the first direction satisfies the above range, an all solid state battery having excellent mechanical reliability may be provided.

A method of forming the cathode layer 121 is not particularly limited, but, for example, the cathode layer 121 may be prepared by mixing the above-described cathode active material, a conductive material (additionally including a solid electrolyte layer if necessary), and a binder, etc., forming a slurry, casting the slurry on a separate support and then curing the slurry. That is, the cathode layer 121 according to the present disclosure may have a structure in which a separate cathode current collector is not disposed, and a cathode active material and a conductive material (and a solid electrolyte) may be mixed in one layer and disposed.

The binder may be used to improve a bonding strength between the active material and the conductive material. The binder may be polyvinylidene fluoride, polyvinyl alcohol, carboxymethylcellulose (CMC), starch, hydroxypropylcellulose, regenerated cellulose, polyvinylpyrrolidone, polytetrafluoroethylene, polyethylene, polypropylene, ethylene-propylene-diene terpolymer (EPDM), sulfonated EPDM, styrene butadiene rubber, fluorine rubber, various copolymers, etc., but is not limited thereto.

The anode layer 122 of the all solid state battery 100 according to the present disclosure may include an anode active material and a conductive material. For example, the anode layer 122 of the all solid state battery 100 according to the present disclosure may be an integrated anode layer 122 in which the anode active material and the conductive material are mixed and disposed.

An anode included in the all solid state battery 100 according to the present disclosure may include a commonly used anode active material. As the anode active material, a carbon-type material, silicon, silicon oxide, silicon-type alloy, silicon-carbon material composite, tin, tin-type alloy, tin-carbon composite, metal oxide, or a combination thereof may be used. The anode active material may include a lithium metal and/or a lithium metal alloy.

The lithium metal alloy may include lithium and a metal/metalloid alloyable with lithium. For example, the metal/metalloid alloyable with lithium may be a Si. Sn. Al, Ge, Pb, Bi, Sb, Si—Y alloy (wherein Y is an alkali metal, an alkaline earth metal, a group 13 to 16 element, a transition metal, a rare-earth element or a combination element thereof, and does not include Si), an Sn—Y alloy (wherein Y is an alkali metal, an alkaline earth metal, a group 13 to 16 element, a transition metal, a transition a metal oxide such as a lithium titanium oxide (Li₄Ti₅O₁₂), etc., a rare-earth element, or a combination element thereof, and does not include Sn) and MnOx (0<x≤2), and the like. The element Y may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Sc, Te, Po, or a combination thereof.

In addition, the oxide of the metal/metalloid alloyable with lithium may be a lithium titanium oxide, a vanadium oxide, a lithium vanadium oxide, SnO2, SiOx (0<x<2), and the like. For example, the anode active material may include one or more elements selected from the group consisting of elements from groups 13 to 16 of the periodic table of elements. For example, the anode active material may include one or more elements selected from the group consisting of Si, Ge, and Sn.

The carbon-type material may be crystalline carbon, amorphous carbon, or a mixture thereof. The crystalline carbon may be graphite such as natural graphite or artificial graphite such as amorphous, plate-like, flake, spherical or fibrous artificial graphite. In addition, the amorphous carbon may be soft carbon (low temperature calcined carbon) or hard carbon, mesophase pitch carbide, calcined coke, graphene, carbon black, fullerene soot, a carbon nanotube, a carbon fiber, etc., but is not limited thereto.

The silicon may be selected from the group consisting of Si, SiOx (0<x<2, for example, 0.5 to 1.5), Sn, SnO₂, or silicon-containing metal alloys and a combination thereof. The silicon-containing metal alloy may include, for example, silicon and at least one of Al, Sn, Ag, Fe, Bi, Mg. Zn, In, Ge, Pb, and Ti.

The anode layer 122 of the all solid state battery 100 according to the present disclosure may use the same conductive material as the cathode layer 121. The anode layer 122 may be manufactured according to almost the same method except that the anode active material is used instead of the cathode active material in the above-described anode manufacturing process.

In an exemplary embodiment of the present disclosure, the average margin a of the anode layer 122 according to the present disclosure in the second direction may satisfy a range of 15% or more and 30% or less of the average width A of the body in the second direction (Y direction). In the all solid state battery 100 according to the present disclosure, when the average margin a of the anode layer 122 in the second direction satisfies the above range, a sufficient adhesion area between the solid electrolyte layers 111 disposed above and below the anode layer 122 may be secured, thereby improving the mechanical strength of the all solid state battery 100.

In an example, the average margin b of the anode layer 122 of the all solid state battery 100 according to the present disclosure in the first direction may be within a range of 5% or more and 10% or less of the average length B of the battery body 110 in the first direction. The average margin b of the anode layer 122 in the first direction may function to provide adhesion between the solid electrolyte layers disposed above and below the anode layer 122 in the same manner as the average margin in the second direction described above. When the average margin b of the anode layer 122 in the rust direction satisfies the above range, an all solid state battery having excellent mechanical reliability may be provided.

In an exemplary embodiment of the present disclosure, the body of the all solid state battery 100 according to the present disclosure may include the cathode penetration electrode 141 and the anode penetration electrode 142. FIGS. 4 and 5 are schematic plan views illustrating the cathode layer 121 and the anode layer 122 according to the present disclosure. Referring to FIGS. 4 and 5, the cathode penetration electrode 141 of the all solid state battery 100 of the present disclosure may be connected to the cathode layer 121 and may penetrate the cathode layer 121 to connect the plurality of cathode layers 121. In addition, the anode penetration electrode 142 may be connected to the anode layer 122 and may penetrate the anode layer 122 to connect the plurality of anode layers 122. In the all solid state battery 100 according to the present disclosure, an external terminal electrode may not be disposed on a head surface of the battery by connecting the plurality of cathode layers 121 and anode layers 122 using a penetration electrode, and a more capacity may be secured by a thickness of the external terminal electrode.

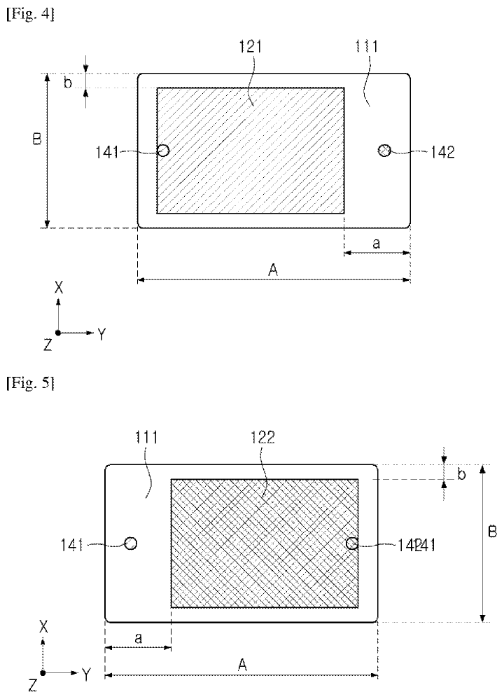

In an exemplary embodiment of the present disclosure, each of the cathode penetration electrode 141 and the anode penetration electrode 142 of the all solid state battery 100 according to the present disclosure may be disposed to penetrate the sixth surface S6 of the body. That is, the cathode penetration electrode 141 and the anode penetration electrode 142 may be drawn out to the sane surface of the body. Referring to FIG. 3, the cathode penetration electrode 141 and the anode penetration electrode 142 of the all solid state battery 100 according to the present disclosure may be disposed to penetrate the sixth surface S6 of the body.

In an example, the cathode penetration electrode 141 and the anode penetration electrode 142 of the all solid state battery 100 of the present disclosure may have different heights in the third direction. In the all solid state battery 100 according to the present disclosure, both the cathode penetration electrode 141 and the anode penetration electrode 142 are not formed to simultaneously penetrate the body in the third direction. Therefore, the cathode penetration electrode 141 and the anode penetration electrode 142 may be arranged to be drawn out to one side of the battery body, and the cathode penetration electrode 141 and the anode penetration electrode 142 may not be drawn out to an opposite surface to a surface from which the penetration electrode is drawn out. Accordingly, the cathode penetration electrode 141 and the anode penetration electrode 142 may have different heights, and the cathode penetration electrode 141 or the anode penetration electrode 142 may have a relatively higher height according to an electrode layer disposed above the cathode layer 121 or the anode layer 122 in the third direction.

In an example, the cathode penetration electrode 141 of the all solid state battery 100 according to the present disclosure may be disposed in contact with an end of the cathode layer 121 in the second direction (Y direction), and the anode penetration electrode 142 may be disposed in contact with an end of the anode layer 122 in the second direction (Y direction). Referring to FIGS. 4 and 5, the cathode penetration electrode 141 of the present disclosure may be disposed in contact with the end of the cathode layer 121 in the second direction (Y direction), more specifically, an end of the fourth surface S4 of the body of the cathode layer 121. In addition, the anode penetration electrode 142 of the present disclosure may be disposed in contact with an end of the anode layer 122 in the second direction (Y direction), more specifically, an end of the third surface S3 of the body of the anode layer 122. As in this example, when the cathode penetration electrode 141 and the anode penetration electrode 142 are respectively disposed in contact with both ends of the body in the second direction (Y direction), the anode layer 122 and the cathode layer 121 may be formed to be larger, thereby contributing to an increase in the capacity.

Materials for forming the cathode penetration electrode 141 and the anode penetration electrode 142 are not particularly limited. For example, the cathode penetration electrode 141 and the anode penetration electrode 142 may be formed using a conductive paste including one or more conductive metals of silver (Ag), palladium (Pd), gold (Au), platinum (Pt), nickel (Ni), copper (Cu), tin (Sn), tungsten (W), titanium (Ti), and alloys thereof. Methods of forming the cathode penetration electrode 141 and the anode penetration electrode 142 are not particularly limited. For example, the cathode penetration electrode 141 and the anode penetration electrode 142 may be formed by forming the body 110 in which the solid electrolyte layer 111, the cathode layer 121 and the anode layer 122 are stacked, then making the body 110 penetrate in the third direction (Z direction) using a laser drill or a mechanical pin punch, and filling the above-described conductive paste.

Further, in the above embodiment, the cathode terminal 131 of the all solid state battery 100 may be disposed on the sixth surface S6 of the body, and the anode terminal 132 may be disposed on the sixth surface S6 of the body to be spaced apart from the cathode terminal 131 in the second direction (Y direction). In this case, the all solid state battery 100 of the present exemplary embodiment may have a so-called lower electrode structure in which the cathode terminal 131 and the anode terminal 132 are disposed only in a lower surface direction of the body and may be mounted in a narrow area of a substrate compared to the exiting head surface electrode type solid state battery 100.

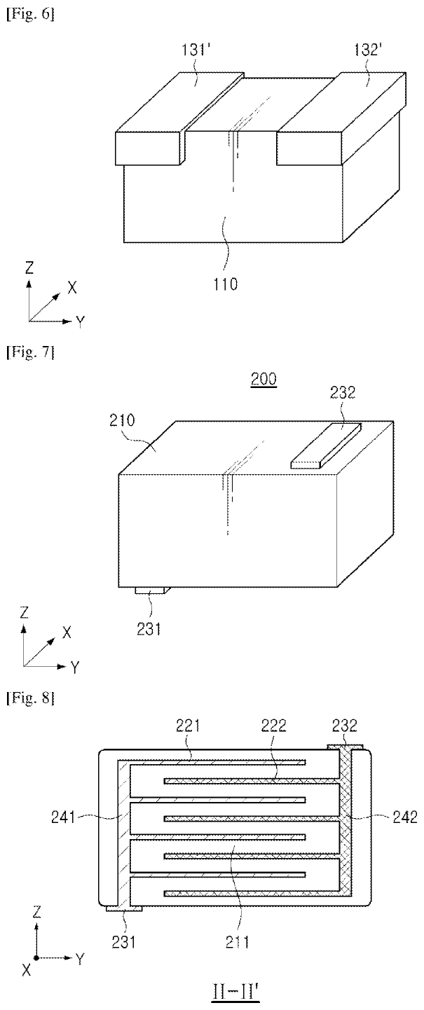

In an example, a part of a cathode terminal 131′ of the all solid state battery 100 according to the present disclosure may be disposed on the sixth surface S6 of the body, and the remaining part of the cathode terminal 131′ may be disposed to extend onto the first surface S1, the third surface S3, and the fourth surface S4. In addition, a part of an anode terminal 132′ may be disposed on the sixth surface S6 of the body, and the remaining part of the anode terminal 132′ may be disposed to extend onto the second surface S2, the third surface S3, and the fourth surface S4. FIG. 6 is a schematic view illustrating the all solid state battery 100 according to an exemplary embodiment in the present disclosure. Referring to FIG. 6, the cathode terminal 131′ be disposed to extend from an area disposed on the sixth surface S6 of the body to the first surface S1, the third surface S3, and the fourth surface S4 of the body, and the anode terminal 132′ may be disposed to extend from an area disposed on the sixth surface S6 of the body to the second surface S2, the third surface S3, and the fourth surface S4 of the body. When the cathode terminal 131′ and the anode terminal 132′ are disposed to extend onto other surfaces of the body as in this example, a bonding strength between the cathode terminal 131′ the anode terminal 132′ may increase, and thus a mechanical reliability of the all solid state battery 100 according to the present disclosure may be further improved.

In another exemplary embodiment of the present disclosure, a cathode penetration electrode 241 of the all solid state battery 200 according to the present disclosure may be disposed to penetrate the sixth surface S6 of the body, and an anode penetration electrode 242 may be disposed to penetrate the fifth surface S5 of the body. That is, the cathode penetration electrode 241 and the anode penetration electrode 242 may be drawn out to opposite surfaces of the body. FIGS. 7 through 9 are views illustrating an all solid state battery 200 according to the present embodiment. Referring to FIGS. 7 through 9, the cathode penetration electrode 241 of the all solid state battery 200 according to the present disclosure may be disposed to penetrate the sixth surface S6 of the body, and the anode penetration electrode 242 may be disposed to penetrate the fifth surface S5 of the body.

Further, in the above embodiment, a cathode terminal 231 of the all solid state battery 200 may be disposed on the sixth surface S6 of the body, and an anode terminal 232 may be disposed on the fifth surface S5 of the body. In this case, the all solid state battery 200 of the present embodiment may have a structure in which the cathode terminal 231 and the anode terminal 232 are disposed on the upper and lower surfaces of the body, respectively, and may be applied between stacked substrates to increase space utilization.

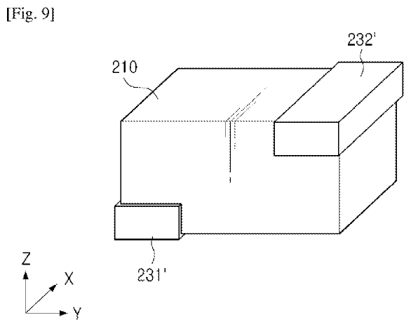

In an example, a part of a cathode terminal 231′ of the all solid state battery 200 according to the present disclosure may be disposed on the sixth surface S6 of the body, and the remaining part of the cathode terminal 231′ may be disposed to extend onto the first surface S1, the third surface S3, and the fourth surface S4 of the body. At the same time, a part of an anode terminal 232′ may be disposed on the fifth surface S5 of the body, and the remaining part of the anode terminal 232′ may be disposed to extend onto the second surface S2, the third surface S3, and the fourth surface S4 of the body. FIG. 9 is a schematic view illustrating the all solid state battery 200 according to an exemplary embodiment in the present disclosure. Referring to FIG. 9, the cathode terminal 231′ may be disposed to extend from an area disposed on the sixth surface S6 of the body to the first surface S1, the third surface S3, and the fourth surface S4 of the body, and the anode terminal 232′ may be disposed to extend from an ara disposed on the fifth surface S5 of the body to the second surface S2, the third surface S3, and the fourth surface S4 of the body. When the cathode terminal 231′ and the anode terminal 232′ are arranged to extend onto other surfaces of the body as in this example, a bonding strength between the cathode terminal 231′ the anode terminal 232′ may increase, and thus a mechanical reliability of the all solid state battery 200 according to the invention may be further improved.

A method of manufacturing the all solid state battery 100 according to the present disclosure is not particularly limited. For example, the all solid state battery 100 may be manufactured by stacking the solid electrolyte layer 111 and the plurality of cathode layers 121 and anode layers 122 in the third direction (Z direction) with the solid electrolyte layer 111 disposed therebetween, forming the cathode penetration electrode 141 and the anode penetration electrode 142 and then sintering the cathode penetration electrode 141 and the anode penetration electrode 142, but the present embodiment is not limited thereto.

The cathode terminal 131 and the anode terminal 132 may be formed, for example, by coating a terminal electrode paste including a conductive metal on withdrawing portions of the cathode penetration electrode 141 and the anode penetration electrode 142, or by coating the terminal electrode paste or powder on the cathode penetration electrode 141 and the anode penetration electrode 142 of the completely sintered battery body 110 and sintering the terminal electrode paste or powder by using a method such as induction heating. In addition, the cathode terminal 131 and the anode terminal 132 may be formed by sputtering or electrically depositing a conductive metal on the withdrawing portions of the cathode penetration electrode 141 and the anode penetration electrode 142, but the present example is not limited thereto. The conductive metal may be one or more conductive metals of, for example, copper (Cu), nickel (Ni), tin (Sn), palladium (Pd), platinum (Pt), gold (Au), silver (Ag), tungsten (W), titanium (Ti), lead (Pb), and alloys thereof, but is not limited thereto.

In an example, the all solid state battery 100 according to the present disclosure may further include a plating layer (not shown) disposed on each of the cathode terminal 131 and the anode terminal 132. The plating layer may include one or more selected from the group consisting of copper (Cu), nickel (Ni), tin (Sn), palladium (Pd), platinum (Pt), gold (Au), silver (Ag), tungsten (W), titanium (Ti), lead (Pb) and alloys thereof, but is not limited thereto. The plating layer may be formed as a single layer or a plurality of layers, and may be formed by sputtering or electric deposition, but is not limited thereto.

While exemplary embodiments have been shown and described above, it will be apparent to those skilled in the art that modifications and variations could be made without departing from the scope of the present invention as defined by the appended claims.

1. An all solid state battery comprising:
a battery body including first and second surfaces opposing each other in a first direction of the battery body, third and fourth surfaces opposing each other in a second direction of the battery body, and fifth and sixth surfaces opposing each other in a third direction of the battery body, a solid electrolyte layer, and a cathode layer and an anode layer stacked in the third direction with the solid electrolyte layer therebetween, a cathode penetration electrode penetrating in the battery body and connecting the cathode layer, and an anode penetration electrode penetrating in the battery body and connecting the anode layer and opposing the cathode penetration electrode in the second direction;
a cathode terminal connected to the cathode penetration electrode; and
an anode terminal connected to the anode penetration electrode,
wherein an average margin of the cathode layer from an edge of the cathode layer to the third surface in the second direction is within a range of 15% or more and 30% or less of an average width of the battery body in the second direction.

2. The all solid state battery of claim 1, wherein an average margin of the anode layer from an edge of the anode layer to the fourth surface in the second direction is within a range of 15% or more and 30% or less of the average width of the battery body in the second direction.

3. The all solid state battery of claim 1, wherein an average margin of the cathode layer from an edge of the cathode layer to the first surface or the second surface in the first direction is within a range of 5% or more and 10% or less of an average length of the battery body in the first direction.

4. The semiconductor package of claim 1, wherein an average margin of the anode layer from an edge of the anode layer to the first surface or the second surface in the first direction is within a range of 5% or more and 10% or less of the average length of the battery body in the second direction.

5. The all solid state battery of claim 1, wherein the cathode layer includes a cathode active material and a conductive material, and the anode layer includes an anode active material and the conductive material.

6. The all solid state battery of claim 1, wherein each of the cathode penetration electrode and the anode penetration electrode is disposed to penetrate the sixth surface of the battery body.

7. The all solid state battery of claim 1, wherein a height of the cathode penetration electrode in the third direction and a height of the anode penetration electrode in the third direction are different from each other.

8. The all solid state battery of claim 1, wherein the cathode terminal is disposed on the sixth surface of the battery body, and
the anode terminal is disposed on the sixth surface of the battery body to be spaced apart from the cathode terminal in the second direction.

9. The all solid state battery of claim 8, wherein a part of the cathode terminal is disposed on the sixth surface of the battery body, and a remaining part of the cathode terminal is disposed to extend onto the first, third and fourth surfaces of the battery body, and
a part of the anode terminal is disposed on the sixth surface of the battery body, and a remaining part of the anode terminal is disposed to extend onto the second, third, and fourth surfaces of the battery body.

10. The all solid state battery of claim 1, wherein the cathode penetration electrode is disposed in contact with an end of the cathode layer in the second direction, and
the anode penetration electrode is disposed in contact with an end of the anode layer in the second direction.

11. The all solid state battery of claim 1, wherein the anode penetration electrode is disposed to penetrate the sixth surface of the battery body, and
the cathode penetration electrode is disposed to penetrate the fifth surface of the battery body.

12. The all solid state battery of claim 11, wherein a part of cathode terminal is disposed on the sixth surface of the battery body, and a remaining part of the cathode terminal is disposed to extend onto the first, third and fourth surfaces of the battery body, and
a part of the anode terminal is disposed on the fifth surface of the battery body, and a remaining part of the anode terminal is disposed to extend onto the second, third, and fourth surfaces of the battery body.
